(19) United States
(12) Patent Application Publication
(10) Pub. No.: US 2024/0097247 A1
(43) Pub. Date: Mar. 21, 2024

(54) LAMINATED FILM AND BATTERY

(71) Applicant: TOYOTA JIDOSHA KABUSHIKI KAISHA, Toyota-shi Aichi-ken (JP)

(72) Inventor: Takuya MATSUYAMA, Susono-shi Shizuoka-ken (JP)

(73) Assignee: TOYOTA JIDOSHA KABUSHIKI KAISHA, Toyota-shi Aichi-ken (JP)

(21) Appl. No.: 18/219,949

(22) Filed: Jul. 10, 2023

(30) Foreign Application Priority Data
Sep. 16, 2022 (JP) 2022-148524

(51) Int. Cl. H01M 50/122; H01M 50/105; H01M 50/117; H01M 50/119; H01M 50/126

(52) U.S. Cl. CPC H01M 50/122; H01M 50/105; H01M 50/117; H01M 50/119; H01M 50/126

(57) ABSTRACT

The laminated film of the present disclosure is a laminated film having a metallic foil, a sealant forming layer laminated to the metallic foil, and an optional glassy protective layer, wherein the sealant forming layer comprises a binder resin joining the glass frit and the glass frit to each other, and wherein the 5% weight loss temperature of the binder resin is lower than the glass transition point of the glass constituting the glass frit.

### CROSS-REFERENCE TO RELATED APPLICATION

This application claims priority to Japanese Patent Application No. 2022-148524 filed on Sep. 16, 2022 incorporated herein by reference in its entirety.

### BACKGROUND

### 1. Technical Field

The present disclosure relates to a laminated film and a battery.

### 2. Description of Related Art

In recent years, various techniques for sealing contents, particularly batteries, using a laminated film have been disclosed (Japanese Unexamined Patent Application Publication No. 2017-045737 (JP 2017-045737 A), Japanese Unexamined Patent Application Publication No. 2018-133175 (JP 2018-133175 A), and Japanese Unexamined Patent Application Publication No. 2020-091995 (JP 2020-091995 A).

For example, JP 2017-045737 A discloses a laminated film for battery exterior in which at least a protective layer, a first adhesive layer, a metallic foil containing at least aluminum, a second adhesive layer, and a resin sealant layer are laminated in this order. In the laminated film for battery exterior, a boehmite film having a contact angle with water being 5° or more and 70° or less is formed on a surface of the metallic foil on a side in contact with the second adhesive layer, the second adhesive layer contains at least an acid-modified polyolefin resin, and the metallic foil and the second adhesive layer are bonded by a thermal lamination method.

JP 2018-133175 A and JP 2020-091995 A disclose an all-solid-state battery in which an all-solid-state battery laminate is sealed with a laminated film.

### SUMMARY

As described in JP 2017-045737 A, the laminated film generally provides barrier properties by a metallic foil containing aluminum, and the laminated films can be thermally welded to each other by a resin sealant layer.

Such a laminated film can thereby provide good barrier properties to the sealed contents. Therefore, various techniques for sealing contents sensitive to moisture and the like, such as battery laminates, foods, pharmaceuticals, electronic components, particularly battery laminates, have been disclosed (JP 2017-045737 A, JP 2018-133175 A, and JP 2020-091995 A).

However, the properties required for the laminated film vary depending on the application. Therefore, there is a need for a novel laminated film having properties different from those of conventional laminated films. In addition, a laminated film for a content particularly sensitive to moisture, for example, a battery laminate, is required to have further higher gas barrier properties. In some embodiments, depending on the application, the laminated film may have high heat resistance.

On the contrary to the above, the present disclosure provides a novel laminated film, particularly a novel laminated film having high gas barrier properties and/or high heat resistance.

The present inventors have found that the above problem can be solved by the following disclosure, and have completed the present disclosure. That is, the present disclosure is as follows.

### First Aspect

A laminated film includes: a metallic foil; and a sealant forming layer laminated on the metallic foil. The sealant forming layer includes glass frit and binder resin mutually joining the glass frit. A 5% weight loss temperature of the binder resin is lower than a glass transition point of glass constituting the glass frit.

### Second Aspect

In the laminated film according to the first aspect, the glass transition point of the glass constituting the glass frit is 250° C. or higher and 500° C. or lower.

### Third Aspect

The laminated film according to the first aspect or the second aspect further includes a glassy protective layer. The glassy protective layer, the metallic foil, and the sealant forming layer are included in the laminated film in this order.

### Fourth Aspect

A battery includes: a solid-state battery laminate; and a laminated film at least partially sealing the solid-state battery laminate. The laminated film includes a metallic foil layer and a glass sealant layer laminated on the metallic foil.

The battery is a solid-state battery.

### Fifth Aspect

In the solid-state battery according to the fourth aspect, the solid-state battery laminate is a sulfide solid-state battery laminate.

According to the present disclosure, it is possible to provide a novel laminated film, particularly a novel laminated film having high gas barrier properties and/or high heat resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a cross-sectional view of one example of a laminated film of the present disclosure;

FIG. 1B is a cross-sectional view of one example of a laminated film of the present disclosure;

FIG. 2A is a cross-sectional view showing the state of bonding laminated films to each other of the disclosures;

FIG. 2B is a cross-sectional view showing the bonded laminated films and the substrate of the present disclosure;

FIG. 3A is a cross-sectional view of a solid-state battery laminate sealed with a laminated film of the present disclosure;

FIG. 3B is a cross-sectional view of a laminate using the disclosed laminated films to encapsulate a solid-state battery laminate.

### DETAILED DESCRIPTION OF EMBODIMENTS

Hereinafter, embodiments of the present disclosure will be described in detail with reference to the drawings. However, the embodiments shown in the drawings are examples of the present disclosure, and do not limit the present disclosure.

### Laminated Film

The laminated film of the present disclosure has a metallic foil and a sealant forming layer laminated to the metallic foil. Here, the sealant forming layer includes a binder resin in which the glass frit and the glass frit are bonded to each other. The 5% weight loss temperature of the binder resin is lower than the glass transition point of the glass constituting the glass frit.

According to the laminated film of the present disclosure, in one aspect, the laminated films of the present disclosure are laminated such that the sealant forming layers are in contact with each other, and thereafter, when heated and optionally pressed, the binder resin of the sealant forming layer is at least partially removed by thermal decomposition, and the glass frit of the sealant forming layer softens, thereby bonding the glass sealant layers formed from the sealant forming layer to each other.

Also according to the laminated film of the present disclosure, in another aspect, the laminated film of the present disclosure may be laminated to another substrate such that the sealant forming layer is in contact with the other substrate, and then, when heated and optionally pressed, the binder resin of the sealant forming layer is at least partially removed by thermal decomposition, and the glass frit of the sealant forming layer softens, thereby bonding the glass sealant layer and the substrate formed from the sealant forming layer.

That is, the laminated film of the present disclosure can be used in the same manner as a conventional laminated film in which a resin sealant layer composed of a thermoplastic resin is used, except that a temperature exceeding a glass transition point of glass constituting a glass frit is used as a heating temperature.

Conventional laminated films have a metallic foil and a resin sealant layer laminated to the metallic foil. The resin sealant layer is made of a thermoplastic resin such as polyethylene. Therefore, in the conventional laminated film, a high barrier property can be provided by the metallic foil in a direction perpendicular to the surface direction of the laminated film. However, with respect to the surface direction of the laminated film, there is a case where the barrier property against the diffusion of the gas passing through the thermoplastic resin in the surface direction from the end portion of the laminated film is insufficient. In addition, the conventional laminated film has a problem in that its heat resistance temperature is limited to the thermoplastic resin used in the resin sealant layer.

On the other hand, according to the laminated film of the present disclosure, since the layer obtained by heating and optionally pressing the sealant forming layer is a glass sealant layer, high gas barrier properties and/or high heat resistance can be provided.

The laminated film of the present disclosure can optionally have a glassy protective layer. In this case, the laminated film of the present disclosure may include a glassy protective layer, the metallic foil, and the sealant forming layer in this order. The glass constituting the glassy protective layer in this case may be the same as or different from the glass constituting the glass frit. The glassy protective layer may also be formed by forming the sealant forming layer on a metallic foil and heating and optionally pressing so that the binder resin of the sealant forming layer is removed by thermal decomposition and the glass frit of the sealant forming layer is softened into a glass layer.

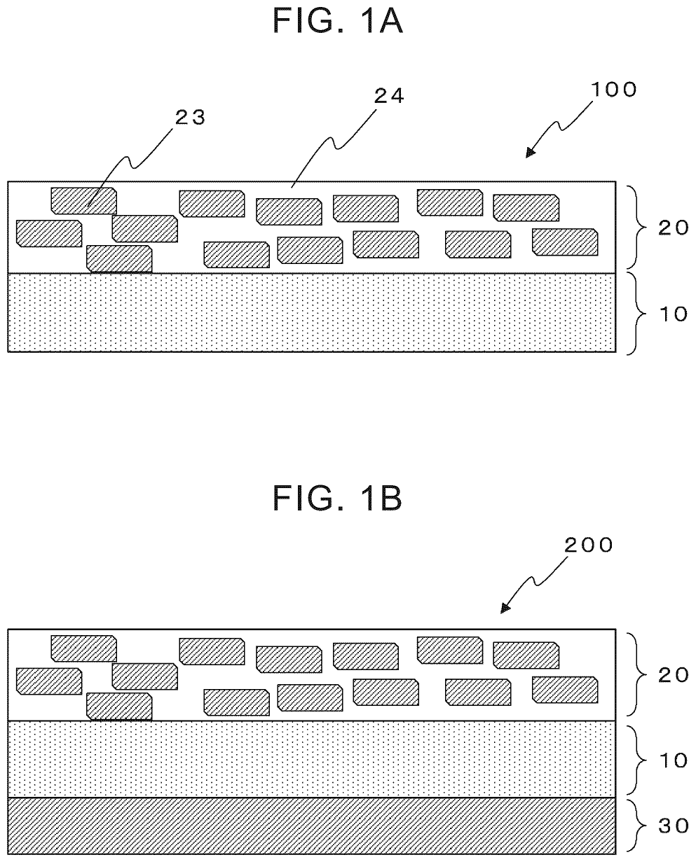

In particular, the disclosed laminated films may have a configuration as shown in the FIGS. 1A and 1B.

The disclosed laminated film 100 shown in FIG. 1A includes a metallic foil and a sealant forming layer 20 laminated to the metallic foil 10. In addition, the sealant forming layer 20 includes a binder resin 24 that bonds the glass frit 23 and the glass frit 23 to each other. In addition, the laminated film 200 shown in FIG. 1B further includes a glassy protective layer 30, and includes a glassy protective layer 30, a metallic foil 10, and a sealant forming layer 20 in this order.

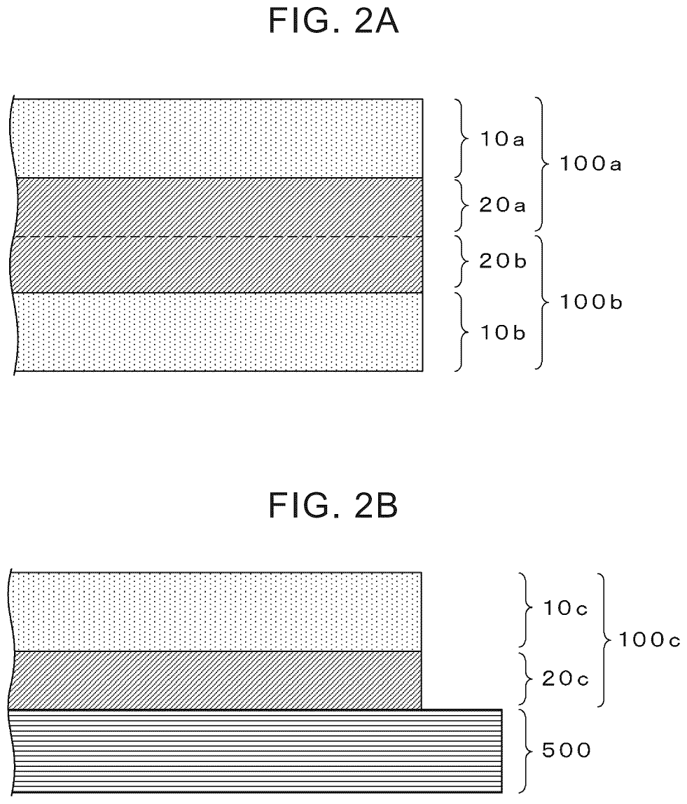

When the laminated films of the present disclosure are laminated in such a manner that the sealant forming layers are in contact with each other, and then heated and optionally pressed, the first metallic foil 10a, the first glass sealant layer 20a derived from the first sealant forming layer, the second glass sealant layer 20b derived from the second sealant forming layer, and the second metallic foil 10b are laminated in this order at the end of the part where the glass sealant layers are bonded to each other, as shown in FIG. 2A. The glass sealant layer 20a and the second glass sealant layer 20b are bonded to each other. Here, the first metallic foil 10a and the first glass sealant layer 20a are partial 100a derived from the first disclosed laminated film. Also, the second metallic foil 10b and the second glass sealant layer 20b are partial 100b derived from the second disclosed laminated films.

In addition, when the laminated film of the present disclosure is laminated to another substrate such that the sealant forming layer is in contact with the other substrate, and then heated and optionally pressed, the metallic foil 10c, the glass sealant layer 20c derived from the sealant forming layer, and the substrate 500 are laminated in this order, as shown in FIG. 2B. A glass sealant layer 20c is bonded to the substrate 500. Here, the metallic foil 10c and the glass sealant layers 20c are partial 100c derived from the disclosed laminated films.

### Metallic Foil

The metallic foil used in the laminated film of the present disclosure may be any metallic foil capable of forming a laminated film. The metallic foil needs to withstand the heat and optional pressure to form the glass sealant layer from the sealant forming layer by heating and optional pressing. In some embodiments, the metallic foil is therefore an aluminum foil, a copper foil or a stainless steel foil, in particular a stainless steel foil. As the metallic foil, a metallic foil used in a sealant film having a conventional resin sealant layer can be used. The metallic foil used in the laminated film of the present disclosure may be subjected to any surface treatment, such as surface roughening, surface slope treatment, etc., in order to improve bonding with the sealant-shaped layer or the glass sealant layer obtained from the sealant-shaped layer.

### Sealant Forming Layer

The sealant-shaped layer used in the laminated film of the present disclosure includes a binder resin that joins the glass frit and the glass frit to each other. Here, the 5% weight loss temperature of the binder resin is lower than the glass transition pointe of the glass constituting the glass frit. According to this, the binder resin is at least partially removed when the glass sealant layer is obtained from the sealant-shaped layer by heating and optionally pressing. This may facilitate the formation of a glass sealant layer from the sealant-shaped layer.

For example, the 5% weight loss temperature of the binder resin may be 5° C. or higher, 10° C. or higher, or 20° C. or higher lower than the glass transition point of the glass (inorganic glass) constituting the glass frit.

The ratio of the glass frit to the binder resin may be 0.1% by mass or more, 0.5% by mass or more, 1% by mass or more, 2% by mass or more, 3% by mass or more, 4% by mass or more, or 5% by mass or more of the binder resin with respect to the total of the glass frit and the binder resin. The ratio of the glass frit to the binder resin may be 20% by mass or less, 15% by mass or less, 10% by mass or less, 8% by mass or less, 6% by mass or less, or 5% by mass or less, based on the total of the glass frit and the binder resin. In some embodiments, this proportion is as small as possible to the extent that it is possible to join the glass film together, in order not to interfere with the formation of the glass sealant layer from the sealant-shaped layer.

Here, a differential thermogravimetric simultaneous measurement device or the like can be used to heat the binder resin under the conditions of a temperature range of 30° C. to 480° C. and a heating rate of 10° C./minute to determine the “5% weight loss temperature” of the binder resin.

As the binder resin that can be used in the laminated film of the present disclosure, any binder resin that can form a sealant forming layer by fixing a glass frit on a metallic foil and has a 5% weight loss temperature lower than the glass transition point of the glass constituting the glass frit can be used. As such a binder resin, any binder resin such as an acrylic binder, a urethane binder, a rubber binder (for example, styrene-butadiene rubber), or a combination thereof can be used. In the case where the binder resin is a combination of a plurality of resins, the 5% weight reduction temperature of the entire binder resin can be considered as the 5% weight reduction temperature.

In addition, the “glass transition point” of the glass constituting the glass frit can be evaluated by differential thermal analysis (DTA) measurement according to JISK0129:2005. Specifically, for example, in the differential curve of DTA curve obtained by using α-alumina as a reference, the temperature of the central portion of the first endothermic peak (the intersection of the tangent at the first inflection point and the second inflection point) can be set as the glass transition point (Tg).

The glass transition point of the glass constituting the glass frit may be 250° C. or higher and 500° C. or lower. Here, the glass transition point may be 250° C. or higher, 270° C. or higher, 280° C. or higher, 290° C. or higher, 300° C. or higher, 310° C. or higher, 320° C. or higher, 330° C. or higher, 340° C. or higher, or 350° C. or higher. The glass transition point may be 500° C. or less, 450° C. or less, 400° C. or less, 350° C. or less, 340° C. or less, 330° C. or less, 320° C. or less, 310° C. or less, 300° C. or less, 290° C. or less, 280° C. or less, or 270° C. or less.

In the laminated film of the present disclosure, when the glass transition temperature of the glass constituting the glass frit is relatively low, for example, 350° C. or lower, the laminated film of the present disclosure can be used to form a sulfide-based solid-state battery by sealing a solid-state battery laminate using a sulfide-based solid electrolyte which has been considered to have relatively low heat resistance unexpectedly.

In this regard, the present disclosure discloses that a positive electrode active material layer containing a lithium niobate-coated nickel-cobalt-manganese-based positive electrode active material and a Li₂S—P₂S₅-based solid electrolyte has been subjected to a heat treatment, so that the ionic conductivity of the solid electrolyte decreases from the time when the ionic conductivity exceeds 300° C., but maintains the ionic conductivity when the ionic conductivity is 360° C. or lower.

Examples of the glass having a relatively low glass transition point include silicate-based glass, borate-based glass, bismuth silicate-based glass, borosilicate-based glass, vanadium oxide-based glass, and phosphate-based glass.

Some silicate-based glasses are based on, for example, SiO₂—ZnO, SiO₂—Li₂O, SiO₂—Na₂O, SiO₂—CaO, SiO₂—MgO, SiO₂—Al₂O₃, and the like. Some bismuth silicate-based glasses include, for example, SiO₂—Bi₂O₃—ZnO, SiO₂—Bi₂O₃—Li₂O, SiO₂—Bi₂O₃—Na₂O, SiO₂—Bi₂O₃—CaO, and the like as their main components. Some borate glasses include, for example, B₂O₃—ZnO, B₂O₃—Li₂O, B₂O₃—Na₂O, B₂O₃—CaO, B₂O₃—MgO, B₂O₃—Al₂O₃ and the like as their main components. Some borosilicate-based glasses are based on, for example, SiO₂—B₂O₃—ZnO, SiO₂—B₂O₃—Li₂O, SiO₂—B₂O₃—Na₂O, SiO₂iB₂O₃—CaO and the like as their main components. Some vanadium oxide glasses include, for example, V₂O₅—B₂O₃, V₂O₅—B₂O₃—SiO₂, V₂O₅—P₂O₅, V₂O₅—B₂O₃—P₂O₅ and the like as their main components. Some phosphate glasses include, for example, P₂O₅—Li₂O, P₂O₅—Na₂O, P₂O₅—CaO, P₂O₅—MgO, P₂O₅—Al₂O₃, and the like as main components.

In addition to the above-described main components, the low glass transition point glass may suitably contain one or more of SiO₂, ZnO, Na₂O, B₂O₃, Li₂O, SnO, BaO, CaO, Al₂O₃, and the like. Here, the “main component” means that the component is more than 50 mass %, 60 mass % or more, 70 mass % or more, 80 mass % or more, or 90 mass % or more of the weight of the inorganic glass.

### Battery

The battery of the present disclosure includes a solid-state battery laminate and a laminated film at least partially sealing the solid-state battery laminate. The laminated film has a metallic foil layer and a glass sealant layer laminated to the metallic foil. Such a battery of the present disclosure can be obtained by at least partially sealing a solid-state battery laminate constituting a power generation element with a laminated film of the present disclosure. Accordingly, in such a battery of the present disclosure, the solid-state battery laminate may be sealed with only the laminated film of the present disclosure, or may be sealed with a combination of the laminated film of the present disclosure and another film or substrate.

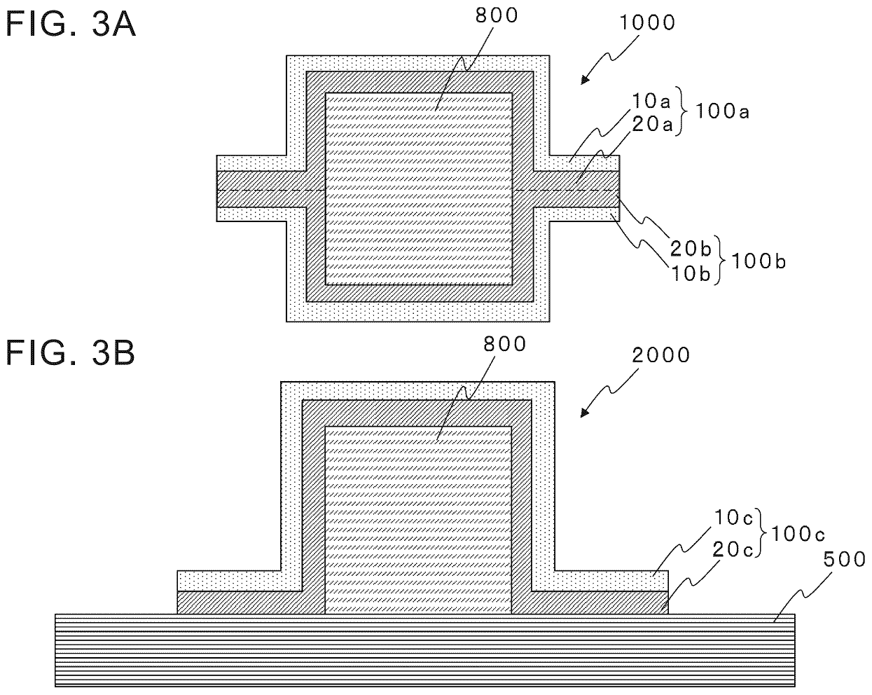

In particular, the presently disclosed batteries may have a configuration as shown in the FIGS. 3A and 3B.

The presently disclosed solid-state battery 1000 shown in FIG. 3A is a battery having a solid-state battery laminate 800 and a laminated film 100a, 100b that encapsulates the solid-state battery laminate 800. The laminated film 100a, 100b have metallic foil layers 10a, 10b and glass sealant layers 20a, 20b laminated on the metallic foils. Another solid-state battery 2000 of the present disclosure, shown in FIG. 3B, is a battery having a combination of a solid-state battery laminate 800, a laminated film 100c that encapsulates the solid-state battery laminate 800, and a substrate 500. The laminated film 100c has a metallic foil layer 10c and a glass sealant layer 20c laminated to the metallic foil.

In the present disclosure, examples of the solid-state battery laminate include a solid-state lithium-ion battery stack, a solid-state sodium-ion battery stack, a solid-state magnesium-ion battery stack, and a solid-state calcium-ion battery stack. In some embodiments, a solid-state lithium ion battery laminate and a solid-state sodium ion battery laminate are used as the solid-state battery laminate. In some embodiments, the solid-state battery laminate is a solid-state lithium-ion battery laminate.

The solid-state battery of the present disclosure may be a primary battery or a secondary battery. In some embodiments, the solid-state battery of the present disclosure is a secondary battery. This is because the secondary battery can be repeatedly charged and discharged, and is useful, for example, as an in-vehicle battery. In some embodiments, the solid-state battery of the present disclosure is a solid-state lithium-ion secondary battery.

In some embodiments, the solid-state battery of the present disclosure may be a sulfide solid-state battery, that is, a battery having a solid-state battery laminate having a positive electrode layer, a solid electrolyte layer, and a negative electrode layer, and at least one of which contains a sulfide solid electrolyte.

In some embodiments, depending on the use of the battery, the battery may be mounted on the printed circuit board using a soldering process, particularly a reflow soldering process.

However, in a conventional laminate battery (pouch battery) in which an exterior is formed of a conventional sealant film using a resin sealant layer, the resin sealant is vulnerable to heat. Therefore, a conventional laminate battery (pouch battery) in which an exterior is formed of a conventional sealant film using a resin sealant layer is considered to be unsuitable for mounting on a printed circuit board using a soldering process.

In contrast, in the battery of the present disclosure, the sealant layer is a glass sealant layer. This allows the battery of the present disclosure to be mounted on a printed circuit board using a soldering process, particularly a reflow soldering process.

In the context of the present disclosure, a “reflow soldering step” means a step of soldering a solder previously applied at a normal temperature by subsequent heating.

In the “reflow soldering process”, a paste-like or cream-like solder is applied or printed to a necessary portion of a printed circuit board. The object to be soldered is then placed in place on the printed circuit board. Finally, the solder is melted through a high-temperature reflow furnace for each printed circuit board, and the object to be soldered and the printed circuit board are soldered. Here, examples of the heating method in the reflow furnace include an infrared method and a hot air method.

For the “reflow soldering step” as described above, the step of flowing the solder melted by the heat between the object to be soldered and the printed circuit board and soldering is sometimes referred to as a “flow soldering step”.

### Example 1

### Method for Producing Laminated Film

A low glass transition point glass (57V₂O₅-23TeO₂-20P₂O₅ (mol %), a glass transition point: 276° C.) frit and a binder resin (acrylic resin, 5% weight loss temperature: about 250° C.) are mixed at 95:5 (weight ratio). Then, the mixture was coated on a stainless steel foil with a doctor blade having a coating gap of 100 μm, thereby forming the laminated film of Example 1. Here, the laminated film of this example had a sealant forming layer including a binder resin in which a glass frit and a glass frit are bonded to each other on a stainless steel foil.

The resulting laminated film was pressed on a uniaxial press under the following conditions:
Press pressure: 10 kN
Press temperature: 276° C.
Press time: 5 minutes

According to this, it was confirmed that the binder resin was partially thermally decomposed and decreased, and the glass frit was sintered to form a glass sealant layer on the stainless steel foil. Further, the remaining binder components were scattered in the glass sealant layer, but did not interfere with the integrity of the glass sealant layer.

### Example 2

Two sealant films obtained in Example 1 were prepared. The prepared sealant films were superimposed so that the sealant forming layers were in contact with each other and pressed under the same conditions as in Example 1.

According to this, it was confirmed that the binder resin was partially thermally decomposed and decreased, and the glass frit was sintered to form a glass sealant layer on the stainless steel foil. And, it was confirmed that the glass sealant layers derived from the sealant forming layers superimposed so as to be in contact with each other are bonded to each other. Further, the remaining binder components were scattered in the glass sealant layer, but did not interfere with the integrity of the glass sealant layer.

### Comparative Example 1

The laminated film of Comparative Example 1 was formed in the same manner as in Example 1 except that styrene butadiene rubber (5% weight loss temperature: about 350° C.) was used instead of acrylic resin (5% weight loss temperature: about 250° C.) as the binder resin, and was pressed in a uniaxial press.

According to this, the reduction of the binder resin due to the thermal decomposition did not substantially occur. Then, the sintering of the glass frit was insufficient.

What is claimed is:

1. A laminated film comprising:
a metallic foil; and
a sealant forming layer laminated on the metallic foil, the sealant forming layer including glass frit and binder resin mutually joining the glass frit, wherein
a 5% weight loss temperature of the binder resin is lower than a glass transition point of glass constituting the glass frit.

2. The laminated film according to claim 1, wherein the glass transition point of the glass constituting the glass frit is 250° C. or higher and 500° C. or lower.

3. The laminated film according to claim 1, further comprising a glassy protective layer, wherein the glassy protective layer, the metallic foil, and the sealant forming layer are included in the laminated film in this order.

4. A battery comprising:
a solid-state battery laminate; and
a laminated film at least partially sealing the solid-state battery laminate, the laminated film including a metallic foil layer and a glass sealant layer laminated on the metallic foil layer, wherein
the battery is a solid-state battery.

5. The solid-state battery according to claim 4, wherein the solid-state battery laminate is a sulfide solid-state battery laminate.
